(19) United States
(12) Patent Application Publication
(10) Pub. No.: US 2013/0075554 A1
(43) Pub. Date: Mar. 28, 2013

(54) Suction Disc Device

(71) Applicants: Yuan-Song Tsai, Tainan City (TW); Sheng-Chi Lin, Tainan City (TW)

(72) Inventors: Yuan-Song Tsai, Tainan City (TW); Sheng-Chi Lin, Tainan City (TW)

(21) Appl. No.: 13/239,495

(22) Filed: Sep. 22, 2011

(51) Int. Cl. F16B 47/00; F16M 13/02

(52) U.S. Cl. 248/205.9; 248/206.3

(57) ABSTRACT

A suction disc device includes at least two suction pads. Each suction pad includes a lower suction disc and an upper suction disc. The lower suction disc is adapted to suck on a supporting object such as a table or floor, etc. The upper suction disc is adapted for holding or placing objects such as beverage bottles, bowls, dishes or cups, etc. The upper and the lower suction discs of each suction pad are in communication with each other by a through-hole. Furthermore, a communicating tube is connected between the two suction pads, so that the two suction pads can be detached synchronously.

### BACKGROUND OF THE INVENTION

1. Field of the Invention

The present invention relates to a suction disc device and, more particularly, to a suction disc device with anti-slipping and positioning functions for placing beverage bottles, cans, bowls, dishes, or cups.

2. Description of the Related Art

Beverage bottles, cans, cups, bowls, dishes, or water containers used by common households can easily fall due to carelessness. It is especially troublesome for households with infants. With the improvement on living standard and fast food culture becoming more popular, office workers and students often place beverage bottles, cans, or cups on tables. However, common beverage bottles, cans, or cups fall easily due to impact from an external force, resulting in drink being spilled out which is troublesome and inconvenient for users.

Cup holders found in the markets are used for holding or placing cups, but the cups still fall easily because of impact from external force. Therefore, the problem needs to be addressed.

### BRIEF SUMMARY OF THE INVENTION

Thus, an objective of the present invention is to provide a suction disc device to improve the aforementioned problem. The suction disc device of the present invention includes a plurality of suction pads. Each suction pad can suck on a supporting object such as a table or floor, etc. for holding or placing objects such as beverage bottles, bowls, dishes, or cups, so that beverage bottles or cans, bowls, dishes, or cups do not fall easily because of impact from an external force. Furthermore, the suction pads of the suction disc device can be detached at the same time.

To achieve this and other objectives, a suction disc device of the present invention includes spaced first and second suction pads. Each of the first and second suction pads includes lower and upper suction discs. The lower suction disc includes a central portion and a lower periphery extending downwards from the central portion. The lower suction disc is formed in a centrally protruded arc-shape for sucking on a supporting object. The upper suction disc includes a bottom portion and an upper periphery extending upwards from the bottom portion. The bottom portion of the upper suction disc is integrally combined with the central portion of the lower suction disc. The upper periphery of the upper suction disc is spaced from the lower periphery of the lower suction disc in a vertical direction. The upper suction disc is formed in a centrally concave arc-shape for an object to be placed on. A through-hole extends through the bottom portion of the upper suction disc and the central portion of the lower suction disc of each suction pad. Further, the suction disc device includes a first communicating tube having first and second ends. The first end of the first communicating tube is connected to the first suction pad, and the through-hole of the first suction pad is in communication with the first communicating tube. The second end of the first communicating tube is connected to the second suction pad, and the through-hole of the second suction pad is in communication with the first communicating tube. In addition, when the suction disc device needs to be detached from the supporting object, simply lift up a portion of the lower suction disc of one of the first and second suction pads to let air flow from the lower suction disc into the upper suction disc through the through-hole, allowing the object placed on the pad to be detached from the upper suction disc easily.

In a preferred form, the first end of the first communicating tube is connected to the central portion of the lower suction disc of the first suction pad, and the second end of the first communicating tube is connected to the central portion of the lower suction disc of the second suction pad.

Preferably, the suction disc device of the present invention further includes a control valve. The control valve includes a valve hole in communication with the first communicating tube and a plug cover for sealing the valve hole.

In a preferred form, the suction disc device of the present invention further includes third and fourth suction pads. Each of the third and fourth suction pads includes the lower suction disc, the upper suction disc, and the through-hole. A second communicating tube is connected between the third and fourth suction pads. Two ends of the second communicating tube are in communication with the through-holes of the third and fourth suction pads respectively, and the second communicating tube is in communication with the first communicating tube.

The present invention will become clearer in light of the following detailed description of illustrative embodiments of this invention described in connection with the drawings.

### DESCRIPTION OF THE DRAWINGS

The illustrative embodiments may best be described by reference to the accompanying drawings where:

FIG. 1 is a perspective view of a suction disc device in accordance with a first embodiment of the present invention.

FIG. 2 is a cross-sectional view taken along plane 2-2 in FIG. 1.

FIG. 3 is a cross-sectional view illustrating a suction pad of the suction disc device of FIG. 1 sucked on a supporting object and showing a cup placed on an upper suction disc of the suction pad.

FIG. 4 is a cross-sectional view similar to FIG. 3, illustrating suction effect of the suction pad of the suction disc device of FIG. 3 being eliminated.

FIG. 5 is a perspective view of a suction disc device in accordance with a second embodiment of the present invention.

FIG. 6 is a cross-sectional view taken along plane 6-6 in FIG. 5.

FIG. 7 is an illustration of a plug cover in FIG. 6 being opened.

FIG. 8 is a perspective view of a suction disc device in accordance with a third embodiment of the present invention.

### DETAILED DESCRIPTION OF THE INVENTION

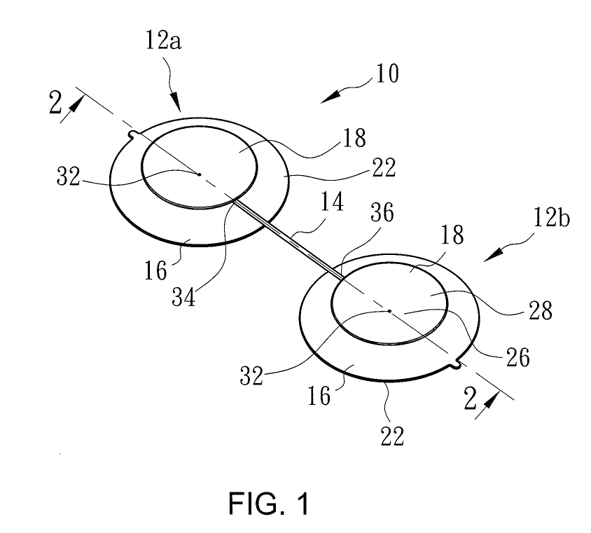

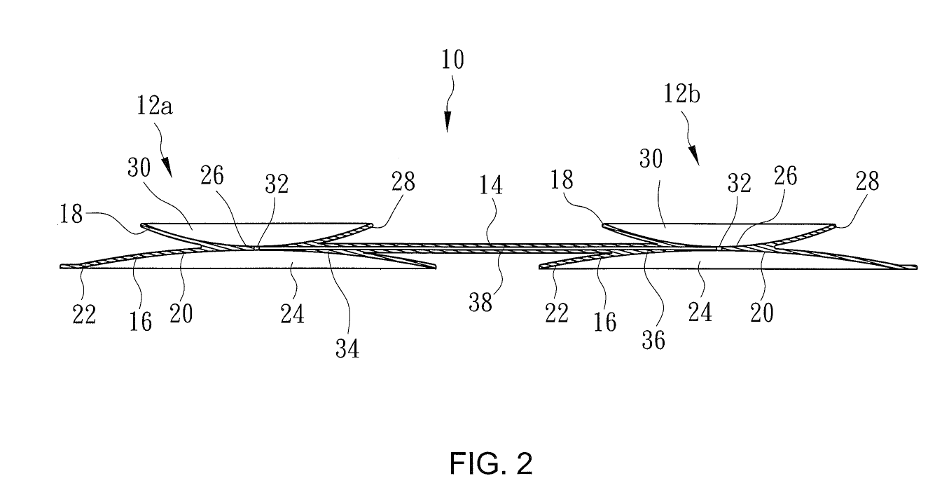

A suction disc device according to a first embodiment of the present invention is shown in FIGS. 1 through 4 of the drawings and generally designated 10. The suction disc device 10 is made of a flexible material such as a synthetic foam rubber or multi-layered laminated fabric. The suction disc device 10 includes two spaced suction pads 12a and 12b and a communicating tube 14 connected between the suction pads 12a and 12b. Each of the suction pads 12a and 12b includes a lower suction disc 16 and an upper suction disc 18. The lower suction disc 16 includes a central portion 20 and a lower periphery 22 extending downwards from the central portion 20. The lower suction disc 16 is formed in a centrally protruded arc-shape, so that a flexible compression space 24 is defined inside the lower suction disc 16. An outer diameter of the upper suction disc 18 is slightly smaller than that of the lower suction disc 16. The upper suction disc 18 includes a bottom portion 26 and an upper periphery 28 extending upwards from the bottom portion 26. The bottom portion 26 of the upper suction disc 18 is integrally combined with the central portion 20 of the lower suction disc 16. The upper periphery 28 of the upper suction disc 18 is spaced from the lower periphery 22 of the lower suction disc 16 in a vertical direction. The upper suction disc 18 is formed in a centrally concave arc-shape, so that a flexible compression space 30 is defined inside the upper suction disc 18. A through-hole 32 extends and goes through the bottom portion 26 of the upper suction disc 18 and the central portion 20 of the lower suction disc 16 in the vertical direction, so that the spaces 24 and 30 are in communication with each other.

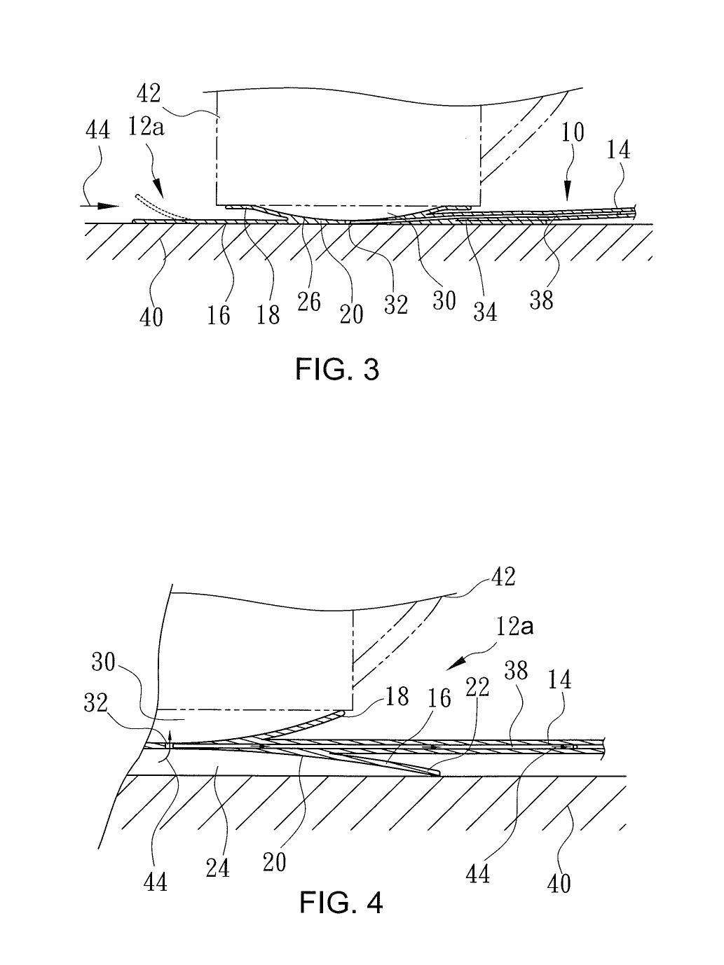

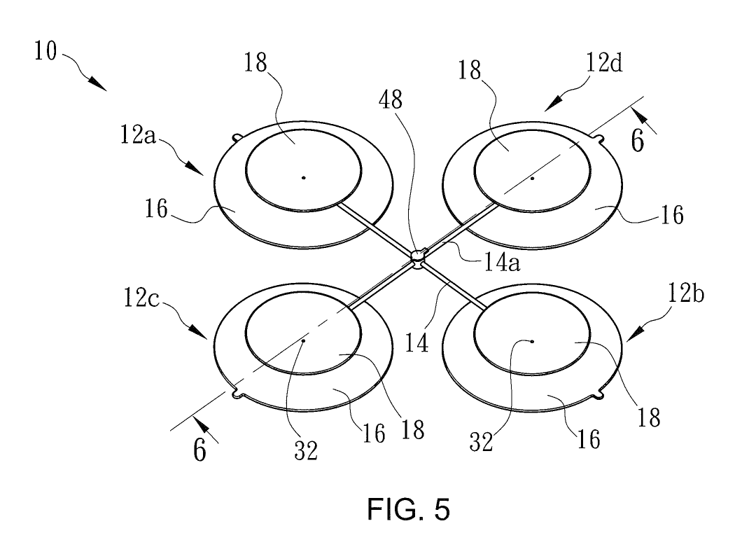

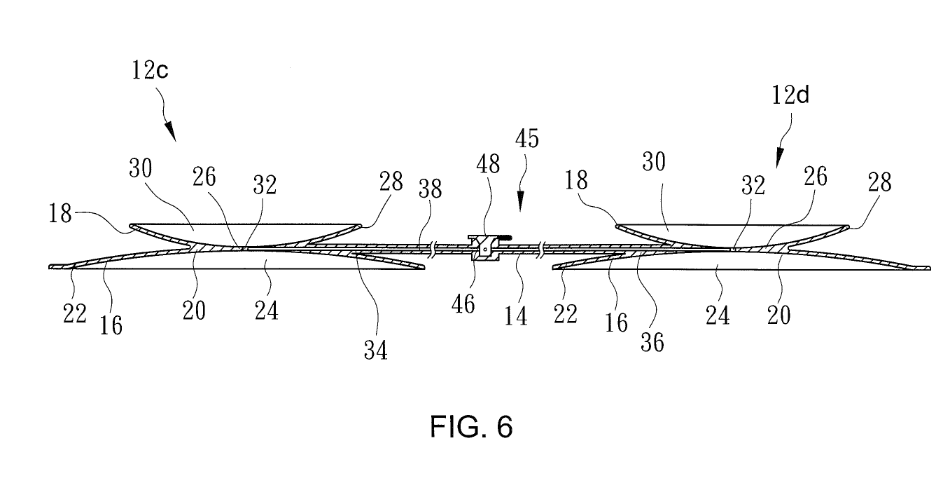

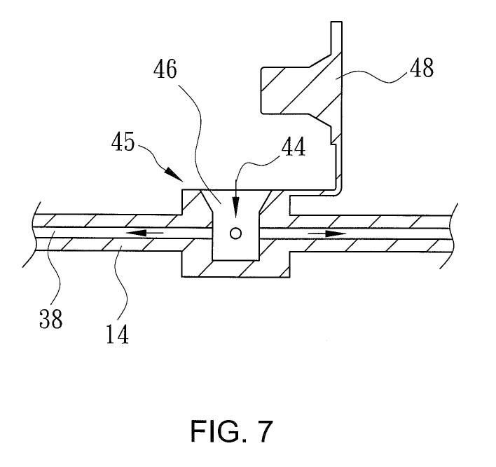

The communicating tube 14 includes spaced first and second ends 34 and 36. The first end 34 is connected to the central portion 20 of the lower suction disc 16 of the suction pad 12a, so that the through-hole 32 of the suction pad 12a is in communication with a tube hole 38 of the communicating tube 14. The second end 36 is connected to the central portion 20 of the lower suction disc 16 of the suction pad 12b, so that the through-hole 32 of the suction pad 12b is in communication with the tube hole 38 of the communicating tube 14. In this embodiment, the first and second ends 34 and 36 of the communicating tube 14 are integrally combined with the central portions 20 of the lower suction discs 16 of the suction pads 12a and 12b respectively. FIG. 3 shows the suction disc device 10 being placed on a supporting object 40 (such as a table or floor, etc.) for holding or placing an object 42 (such as a cup, a bowl, a dish, or a bottle, etc.). In use, the lower suction discs 16 of the suction pads 12a and 12b of the suction disc device 10 are placed on the supporting object 40, and the air in the space 24 of each lower suction disc 16 is discharged when each lower suction disc 16 is pressed downward, so that the lower suction discs 16 of the suction pads 12a and 12b produces sucking effect and, therefore, can be fixed on the supporting object 40. On the other hand, place objects 42 on the upper suction discs 18 of the suction pads 12a and 12b of the suction disc device 10 respectively, and press downward the objects 42 so that the air in the space 30 of each upper suction disc 18 is discharged. Thus, the objects 42 will be sucked and fixed on the upper suction discs 18 respectively. Accordingly, the objects 42 can be placed steadily on the supporting object 40 through the suction disc device 10. Further, When the objects 42 need to be detached from the suction pads 12a and 12b, simply lift up a portion of the lower suction disc 16 of one of the suction pads (the suction pad 12a as shown in FIG. 3) to let air 44 flow into the spaces 24 and 30 of the suction pad 12a through the through-hole 32 and into the suction pad 12b through the communicating tube 14 in order to synchronously eliminate the suction effect of the lower and upper suction discs 16 and 18 of the suction pads 12a and 12b (see FIG. 4). Thus, objects 42 can be easily removed from the suction pads 12a and 12b, and the two suction pads 12a and 12b can also be detached from the supporting object 40 synchronously without having to be removed one by one. The suction disc device 10 shown in FIGS. 5 and 7 is a modification of that shown in FIGS. 1 through 4. In the embodiment, suction disc device 10 includes four suction pads 12a, 12b, 12c, and 126d, a first communicating tube 14 connected between the suction pads 12a and 12b, and a second communicating tube 14a connected between the suction pads 12c and 12d. Each of the suction pads 12a, 12b, 12c, and 12d includes lower and upper suction discs 16 and 18 those are similar to lower and upper suction discs 16 and 18 in the first embodiment. Description of the parts of suction disc device 10 shown in FIGS. 5 and 7 identical to those shown in FIGS. 1 through 4 is omitted. The communicating tubes 14 and 14a are intersected and in communication with each other. In this embodiment, the suction disc device 10 further includes a control valve 45 which is disposed at the intersection point of the two communicating tubes 14 and 14a. The control valve 45 includes a valve hole 46 in communication with the communicating tubes 14 and 14a, and a plug cover 48 which can be opened and is used to seal the valve hole 46. When the valve hole 46 is sealed by the plug cover 48, the suction pads 12a, 12b, 12c, and 12d of the suction disc device 10 can be sucked on the supporting object 40 respectively, so that the upper suction discs 18 of the suction disc device 10 can be ready for objects 42 to be placed on. When objects 42 need to be removed, simply open the plug cover 48 (see FIG. 7) to let external air 44 flow into each of the suction pads 12a, 12b, 12c, and 12d through the communicating tubes 14 and 14a to synchronously eliminate the suction effect of the lower and upper suction discs 16 and 18 of the suction pads 12a, 12b, 12c and 12d, so that the objects 42 can be easily removed from the suction disc device 10. It can be appreciated that the control valve 45 can be disposed on the communicating tube 14 of the suction disc device 10 of the first embodiment to control the tube hole 38 of the communicating tube 14 to be closed or opened.

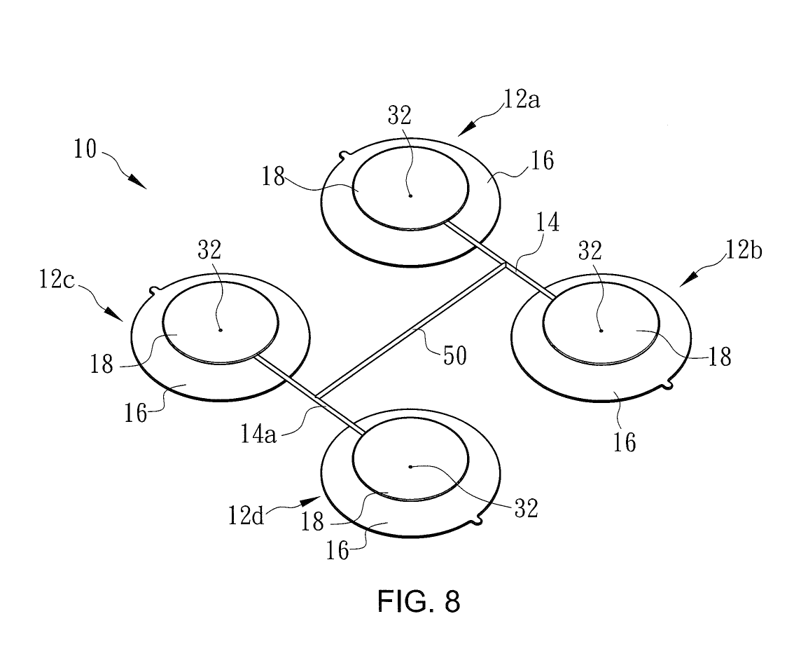

FIG. 8 shows a suction disc device 10 of a third embodiment of the present invention. The suction disc device 10 includes four suction pads 12a, 12b, 12c, and 12d, a first communicating tube 14 connected between the suction pads 12a and 12b, and a second communicating tube 14a connected between the suction pads 12c and 12d. A communicating pipe 50 is connected between the communicating tubes 14 and 14a. When the suction disc device 10 needs to be detached from a supporting object, a portion of the lower suction disc 16 of one of the suction pads 12a, 12b, 12c, and 12d is lifted up, so that an external air flows into each of the suction pads 12a, 12b, 12c, and 12d through the through-hole 32, the communicating tubes 14 and 14a, and the communicating pipe 50 to synchronously eliminate the suction effect of the lower and upper suction discs 16 and 18 of the suction pads 12a, 12b, 12c, and 12d.

It can be appreciated that the suction disc device 10 of the present invention is not limited to be used for fixing bottles, cans, or cups, etc. The suction disc device 10 can also be applied for stationery or other objects for fixing purpose.

Thus since the invention disclosed herein may be embodied in other specific forms without departing from the spirit or general characteristics thereof, some of which forms have been indicated, the embodiments described herein are to be considered in all respects illustrative and not restrictive. The scope of the invention is to be indicated by the appended claims, rather than by the foregoing description, and all changes which come within the meaning and range of equivalency of the claims are intended to be embraced therein.

1. A suction disc device comprising:
first and second suction pads, with each of the first and second suction pads including lower and upper suction discs, with the lower suction disc including a central portion and a lower periphery extending downwards from the central portion, with the lower suction disc formed in a centrally protruded arc-shape for sucking on a supporting object, with the upper suction disc including a bottom portion and an upper periphery extending upwards from the bottom portion, with the bottom portion of the upper suction disc integrally combined with the central portion of the lower suction disc, with the upper periphery of the upper suction disc spaced from the lower periphery of the lower suction disc in a vertical direction, with the upper suction disc formed in a centrally concave arc-shape for an object to place on, with a through-hole extending through the bottom portion of the upper suction disc and the central portion of the lower suction disc of each of the first and second suction pads; and
a first communicating tube connected to the first and second suction pads, with the through-holes of the first and second suction pads in communication with the first communicating tube.

2. The suction disc device according to in claim 1, with the first communicating tube including spaced first and second ends, with the first end of the first communicating tube connected to the central portion of the lower suction disc of the first suction pad so that the first end of the first communicating tube in communication with the through-hole of the first suction pad, and with the second end of the first communicating tube connected to the central portion of the lower suction disc of the second suction pad so that the second end of the first communicating tube in communication with the through-hole of the second suction pad.

3. The suction disc device according to in claim 2, further comprising:
a control valve including a valve hole in communication with the first communicating tube and a plug cover for sealing the valve hole.

4. The suction disc device according to claim 2, further comprising:
third and fourth suction pads, with each of the third and fourth suction pads including the lower suction disc, the upper suction disc, and the through-hole, with a second communicating tube connected between the third and fourth suction pads, with two ends of the second communicating tube in communication with the through-holes of the third and fourth suction pads respectively, and with the second communicating tube in communication with the first communicating tube.

5. The suction disc device according to claim 2, further comprising:
third and fourth suction pads, with each of the third and fourth suction pads including the lower suction disc, the upper suction disc, and the through-hole, with a second communicating tube connected between the third and fourth suction pads, with two ends of the second communicating tube in communication with the through-holes of the third and fourth suction pads respectively, and with the second communicating tube intersected and being in communication with the first communicating tube.

6. The suction disc device according to claim 5, further comprising:
a control valve disposed at an intersection point of the first and second communicating tubes and including a valve hole and a plug cover for sealing the valve hole, and with the valve hole in communication with the first and second communicating tubes.
